(19) United States
(12) Patent Application Publication
(10) Pub. No.: US 2014/0067717 A1
(43) Pub. Date: Mar. 6, 2014

(54) METHODS AND SYSTEMS FOR IDENTIFYING OVERVALUED, UNDERVALUED, AND CORRECTLY VALUED FINANCIAL RETURNS

(71) Applicants: VICTOR J. TREMBLAY, Corvallis, OR (US); Jayendra Gokhale, Daytona Beach, FL (US); Carol Horton Tremblay, Corvallis, OR (US)

(72) Inventors: VICTOR J. TREMBLAY, Corvallis, OR (US); Jayendra Gokhale, Daytona Beach, FL (US); Carol Horton Tremblay, Corvallis, OR (US)

(21) Appl. No.: 14/016,069

(22) Filed: Aug. 31, 2013

Related U.S. Application Data
(60) Provisional application No. 61/696,800, filed on Sep. 4, 2012.

(51) Int. Cl. G06Q 40/06

(52) U.S. Cl. CPC G06Q 40/06
USPC 705/36 R

(57) ABSTRACT

Methods and systems for identifying and reporting an index of overvaluation and undervaluation of a financial instrument due to behavioral bias of traders, including but not limited to stocks, bonds, mutual funds, and options by producing a fundamental valuation index that equals zero when the actual returns equal the fundamental economic returns of the instrument as predicted by the model, and that does not equal zero when the returns are overvalued or undervalued, to enable an investor to formulate optimal investment strategies.

### CROSS-REFERENCE TO RELATED APPLICATION

The present application claims the benefit of priority of U.S. provisional patent application 61/696,800, filed Sep. 4, 2012.

### FIELD OF INVENTION

The methods and systems described herein relate generally to identifying financial instruments that are consistent with an investment strategy, and enable investors to determine whether returns of a financial instrument are undervalued, overvalued or correctly valued relative to returns that are based on economic fundamentals.

### BACKGROUND

Individual and institutional investors typically use a variety of selection criteria to determine their investment portfolio. They have many investment options, including but not limited to the purchase or sale of financial instruments such as stocks, bonds, commodity futures, etc., in U.S. and foreign capital markets. A fundamental question in portfolio management is how to choose a mix of financial instruments and securities that will earn the highest expected return for a predetermined level of risk.

Investors typically use one or both of two methods for screening financial instruments. The first is a fundamental economic analysis in which investors estimate the fundamental or intrinsic value of an instrument based on microeconomic and macroeconomic data, including but not limited to expected future returns and market growth. An attractive investment would include an instrument in which its fundamental value deviates from its market value, buying an instrument with a fundamental value above its market value and selling an instrument with a fundamental value below its market value. The second is a technical analysis in which an investor uses price history and expected trader sentiment to predict a future price. Attractive investments would include instruments in which trader sentiment is expected to rise, and therefore tend to push up the price of such instruments. This second form of investing can cause market prices to deviate from their fundamental economic values. Overvaluation is defined as the occurrence of the market price of an instrument being greater than its fundamental value. Undervaluation is defined as the occurrence of the market price of an instrument being less than its fundamental value. Concerns with overvaluation and undervaluation in financial markets are the focus of behavioral economics and finance (Barberis and Thaler, 2003).

In an efficient financial capital market, investment returns will reflect economic fundamentals. In the case of a company's stock, this means that the market value of the stock will accurately reflect the fundamental value of the company, defined as the present value of the stream of expected future profits. In such a market, arbitrage will quickly eliminate above average return opportunities (Fama, 1965; Malkiel, 2011). Competition in financial markets will tend to equalize risk adjusted returns on securities, making it difficult for investors to earn above average returns. In order to earn above average returns, a financial investor must identify and take advantage of any above or below average return opportunities more quickly than competing investors.

In less than perfectly efficient capital markets, above average return opportunities may persist into the medium run (Lo, 2004). For example, noise traders who base their decisions on factors other than economic fundamentals exhibit behavioral biases that cause the returns of a particular financial instrument to deviate from returns based on fundamental economic value (De Long et al., 1989 and 1990). A positive behavioral bias causes what is called a financial bubble that is associated with overvaluation. Evidence from behavioral finance suggests that such bubbles exist and their presence may create above average return opportunities in the medium run. However, conventional investments methods in finance are unable to accurately predict when market returns are over, under, or correctly valued.

One method for predicting the theoretical stock price was developed by Masuyama et al., U.S. Patent Publication 2008/0168005 A1. Their approach assumes that the stock price of a company is a function of fundamental financial determinants, but it fails to account for fluctuations in the macroeconomic environment. Lifson, U.S. Patent Publication 2005/0131794 A1 discloses a regression model to estimate the degree to which the market price of a stock is over-priced or under-priced relative to its predicted value. However, both Lifson and Masuyama et al fail to account for overvaluation or undervaluation that can be caused by behavioral biases of day and noise traders.

### SUMMARY

The presently described methods overcome the above identified problems by enabling the user to determine whether the returns of a financial instrument are overvalued or undervalued relative to fundamental economic values. A first preferred embodiment comprises a regression model or method of analyzing returns that includes the advantageous improvement of a component (or “error term”) to account for behavioral biases in addition to the error term found in conventional regression models (Aigner et al., 1977; Meeusen and van den Broeck, 1977). The conventional error term found in efficient market models is associated with rational traders who make their investment decisions on long run economic fundamentals. The newly formulated error term captures the behavioral biases of noise traders, such as over optimism, who base their decisions on short-term patterns and trends rather than on economic fundamentals. The presently most preferred method of analysis, referred to as the composite error model, is based on advantageous, novel and non-obvious efficiency estimations applied to issues of over and under valuation in finance or other fields.

The present methods identify overvalued, undervalued and correctly valued financial returns, estimate a composite error to test for overvaluation or undervaluation, generate a fundamental valuation index, and generate a moving-average fundamental valuation index for an individual financial instrument.

The statistical significance of the second error term implies that such behavioral biases cause overvaluation or undervaluation. The presently described methods produce a fundamental valuation index, which equals zero when a financial instrument's market returns equal the fundamental value of returns predicted by the previously mentioned model. The index is different from zero when returns are either overvalued or undervalued. The larger the absolute value of the index, the greater the degree of behavioral bias.

One advantage of the first preferred embodiment is that it can detect the influence of behavioral bias on the returns of a financial instrument. The ability to detect significant biases and trends in these biases provides investors with a valuable tool that can be used to create a portfolio of financial instruments whose returns are expected to outperform the market as a whole. These and other embodiments, features, aspects, and advantages of the invention will become better understood with regard to the following description, appended claims and accompanying drawings.

### BRIEF DESCRIPTION OF THE DRAWINGS

The foregoing aspects and the attendant advantages of the present methods and systems will become more readily appreciated by reference to the following detailed description, when taken in conjunction with the accompanying drawings, wherein:

FIG. 1 is a schematic representation of a preferred system including a general purpose computer configured to be programmed for executing the methods described herein; and,

FIG. 2 is a functional block diagram illustrating a set of steps for a preferred method of identifying overvalued, undervalued and correctly valued financial returns to estimate a composite error used to test for overvaluation or undervaluation, to generate the fundamental valuation index and to generate a moving-average fundamental valuation index for an individual financial instrument.

Reference symbols or names are used in the figures to indicate certain components, aspects or features shown therein. Reference symbols common to more than one figure indicate like components, aspects or features shown therein.

### DETAILED DESCRIPTION

A first preferred embodiment described herein concerns valuation of stock returns. Alternate embodiments may be used to value virtually any tradable financial instrument, including but not limited to stocks, bonds, and derivatives, for any capital market, including but not limited to those that are traded on the New York Stock Exchange (U.S.), London Stock Exchange (England), and the Tokyo Stock Exchange (Japan). Alternate embodiments may be used to value one or more of a plurality of financial instruments. Those skilled in the art of finance will understand that the description found here has broad application, is exemplary and is not limited in scope to the embodiments and examples described herein.

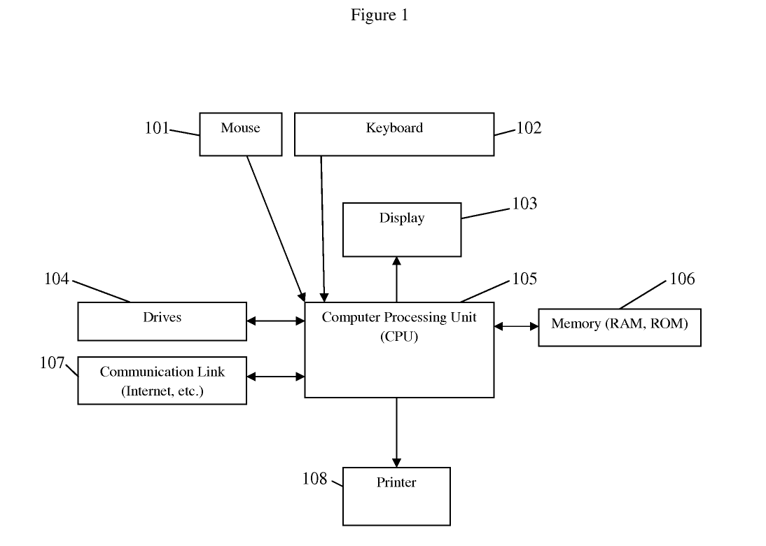

FIG. 1 illustrates a system including a general purpose computer, peripheral devices, included operating system and application software configured to be used to perform the presently described methods of valuing a tradable financial instrument. The computer may be a main frame, desktop, PC or Apple brand computer, and is capable of executing a conventional operating system including but not limited to MAC-OS® or Microsoft Windows® brand operating systems. In the first preferred embodiment the computer includes a mouse 101, keyboard 102, display 103, drives (including but not limited to a hard drive, disk drive, and USB drive) 104, central processing unit (CPU) 105, memory (random access memory, RAM, and read only memory, ROM) 106, communication link (including but not limited to an internet connection) 107, and input/output devices (including but not limited to a printer) 108. Computers other than general purpose computers without conventional operating systems can also be used in alternate embodiments. Multiple computers may be associated with each other or networked over communication link 107 and be employed simultaneously. The first preferred embodiment preferably uses a software application stored on drive 104 or on the network via communication link 107 and may be executed by CPU 105 or over the network via communication link 107.

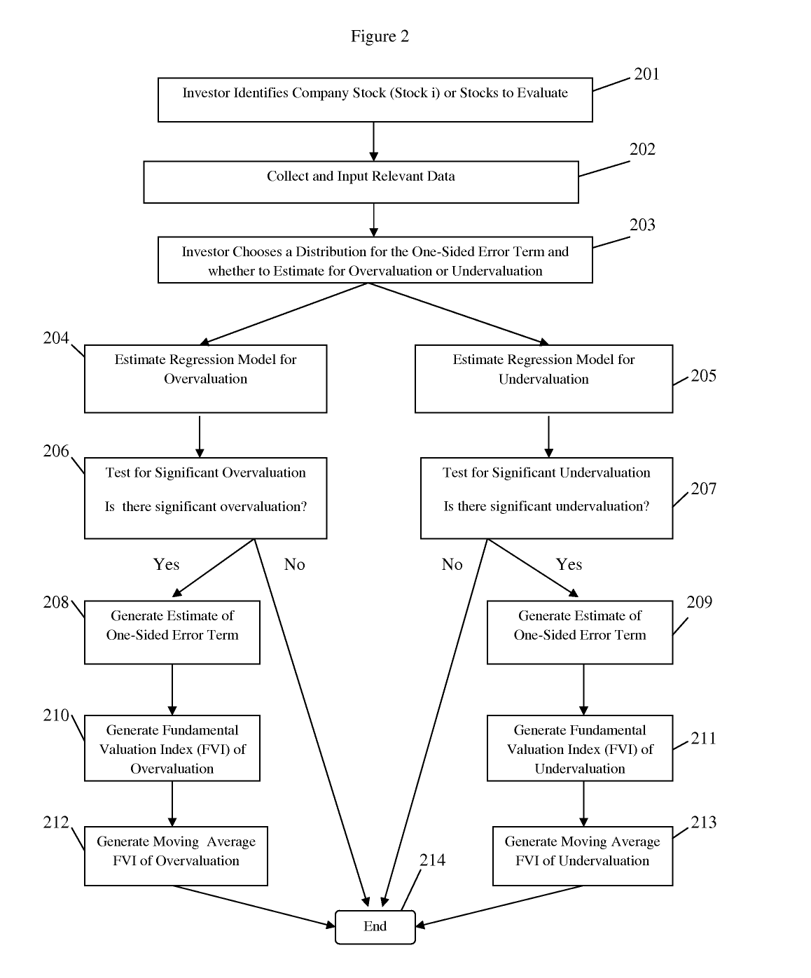

FIG. 2 illustrates steps performed by the preferred method for valuing a tradable financial instrument, including evaluating the behavioral bias of stock returns, assuming that each considered company offers a single stock. In first block 201, the investor/user identifies a set of company stocks to be evaluated, which might include but is not limited to members of Dow Jones Industrial or a set of companies with a given risk profile, for consideration in the investor's portfolio. Let N equal the number of companies in the set that are under consideration. In block 202, historical daily data are collected for a particular period, which may include, for example 120 to 250 recent trading days, on the stock prices of companies to be evaluated and on other relevant financial data on market conditions, including but not limited to the Standard & Poor 500 Index and other relevant macroeconomic indices. The choice of company stocks and relevant market and macroeconomic indices is based on investor/user preference. Stock returns for each particular company, denoted by stock i, are matched with market returns and macroeconomic indices for T periods (observations). The historical data are retrieved from a suitable source and are stored in a file, such as a user's computer file.

Returns for company i at period t (Rᵢₜ) are defined as the percentage change in the stock price per share (pᵢₜ) from the prior period (t−1) to the current period (t) plus dividends. In this embodiment, the period is one day. Returns are calculated by the following formula:

$${R}_{it} = \frac{{p}_{it} - {p}_{it - 1} + {d}_{it}}{{p}_{it - 1}} . \qquad ( 1 )$$

In this embodiment and in the traditional market model, market returns are used to explain Rᵢₜ (MacKinlay, 1997). Returns for appropriate market index at time t (Rₘₜ) are defined as the percentage change in the index price (pₘₜ) from one day or period to the next. This is given by the following formula:

$${R}_{mt} = \frac{{p}_{mt} - {p}_{mt - 1} + {d}_{mt}}{{p}_{mt - 1}} . \qquad ( 2 )$$

The traditional regression model can be written:

Rᵢₜ=αᵢ+βᵢRₘₜ+νᵢₜ, (3)

where αᵢ and βᵢ are parameters to be estimated, and νᵢₜ is called an error term. The term αᵢ represents the expected returns for stock i when market returns are zero. The value of βᵢ is the change in company returns associated with a 1 percentage point increase in the market index price. The component υᵢₜ is due to unanticipated events or shocks such as natural disasters, wars, the discovery of new crude oil reserves, etc., that can have positive or negative effects on returns. The value of υᵢₜ cannot be anticipated and is expected to equal 0 on average.

The problem with the traditional model is that it fails to account for the behavioral biases of some traders that are observed in the behavioral finance literature (Barberis and Thaler, 2003; Lo, 2004). Estimates of the regression model in Equation (3) are misleading, and investors cannot tell if there is overvaluation or undervaluation of stocks. This invention overcomes these shortcomings by first adding a second error term or component to the model, μᵢₜ. That is, the traditional model can be improved upon in this way:

Rᵢₜ=αᵢ+βᵢRₘₜ+υᵢₜ+μᵢₜ (4)

where μᵢₜ is an error term that captures the behavioral biases of noise traders who base their decisions on short-term patterns and trends rather than on economic fundamentals. With no behavioral bias, μᵢₜ=0, the stock returns are valued according to economic fundamentals, and the traditional model is appropriate. With bias that causes overvaluation, μᵢₜ>0; with bias that causes undervaluation, μᵢₜ<0.

The term, υᵢₜ+μᵢₜ, can be written more simply as εᵢₜ=υᵢₜ+μᵢₜ. εᵢₜ is called a composite or dual error term. The model in this invention can be described by, but is not limited to, a linear specification of the market model that includes this dual error term. This can be written as the following regression equation:

Rᵢₜ=αᵢ+βᵢRₘₜ+εᵢₜ. (5)

Estimation of this model can produce statistically unbiased estimates of αᵢ and βᵢ whether stocks are overvalued, undervalued or correctly valued by investors; can enable statistical testing for overvaluation or undervaluation; and can allow estimation of the extent of overvaluation or undervaluation (μᵢₜ).

In the preferred embodiment, the regression model with a composite error term is estimated by the method of maximum likelihood. Looking at the actual data on Rₘₜ and Rᵢₜ, the maximum likelihood procedure finds the estimates of αᵢ and βᵢ that would have most likely generated the observed data. A number of different statistical packages could be used to obtain maximum likelihood estimates. In other embodiments, other estimation techniques could be used.

Those skilled in the art of statistics will know that to obtain maximum likelihood estimates of the regression equation, the probability distributions of υᵢₜ, μᵢₜ, and therefore, εᵢₜ must be specified. The two errors, υᵢₜ and μᵢₜ, are assumed to be distributed independently of each other. From the traditional market model, υᵢₜ is a white noise error term that is assumed to be independently, identically, and normally distributed with 0 mean and a variance of σ_{ν}², υᵢₜ˜N(0, σ_{ν}²), where −∞<υᵢₜ<∞. This means that random events or shocks can be positive (raise stock returns above that predicted from market returns) or negative (reduce stock returns below that predicted from market returns) in different time periods for a particular stock. These unanticipated shocks are assumed to average out to zero over the observations. It also means that the distribution of shocks is a normal bell-shaped curve, with values close to zero (small shocks) more likely and values far from zero (large shocks) unlikely. The symbol, σ_{ν}², stands for the variance which indicates how widely the values of the shocks are spread.

In this embodiment, μᵢₜ is independently and identically distributed as a half-normal distribution. This means that the bell-shaped distribution is cut in half, with most of the observations at zero and fewer at the extreme end of the distribution. μᵢₜ is called a one-sided error term. Other suitable asymmetric distributions include but are not limited to the exponential, truncated-normal, and gamma distributions. Maximum likelihood estimates are obtained separately for the overvaluation case and for the undervaluation case.

For the maximum likelihood overvaluation model, the half-normal distribution is the top half (right-hand side) of the bell. μᵢₜ is said to be distributed nonnegative half normal or N⁺(0, σ_{μ}²). This distribution allows μᵢₜ to be zero in some periods (periods with no noise trading) and positive in some periods where overly optimistic noise trading is present. Values of μᵢₜ at the extreme positive end (the tail) might represent a bubble. Undervaluation, μᵢₜ<0, is ruled out in all periods.

For the maximum likelihood undervaluation model, the half-normal distribution is the bottom half (left-hand side) of the bell. μᵢₜ is nonpositive half normal, N⁻(0, σ_{μ}²) and can take zero values (no undervaluation) in some periods and negative values (undervaluation) in some periods. Overvaluation is ruled out in all periods.

The distribution of the composite error term εᵢₜ=υᵢₜ+μᵢₜ is skewed in the direction of the bias that is caused by noise trading. With overvaluation (μᵢₜ>0), it is skewed in the positive direction. With undervaluation (μᵢₜ<0), it is skewed in the negative direction. In the absence of behavioral bias (μᵢₜ=0), εᵢₜ is not skewed and is normally distributed.

Those skilled in the art of statistics know that based on these probability distributions, the regression model can be estimated by maximizing the following log likelihood function.

$$ln L ( α , β , {σ}_{υ} , {σ}_{μ} ) = - T ln ( σ ) + \frac{T}{2} ln ( 2 \text{/} π ) + {\sum }_{t = 1}^{T} [ ln Φ ( \frac{s \cdot {ɛ}_{it} λ}{σ} ) - \frac{1}{2} {( \frac{{ɛ}_{it}}{σ} )}^{2} ] , \qquad ( 6 )$$

where T is the number of time periods, σ=\sqrt{σ_{μ}²+σ_{υ}²}, λ=σ_{μ}/σ_{υ}, and Φ(.) is the cumulative standard normal distribution. Variable s is a sign indicator, which equals 1 in the overvaluation specification and equals −1 in the undervaluation specification.

The regression model is estimated, based on the investor's decision to test for overvaluation or undervaluation. At block 203, the investor chooses whether to test for overvaluation or undervaluation and chooses the distribution assumption for, μᵢₜ, which is half-normal in this embodiment but could be another distribution such as an exponential, truncated-normal, or gamma distribution.

Estimation is carried out and the software provides estimation results, block 204 for overvaluation and block 205 for undervaluation. In the preferred embodiment of the invention, a chi-square (χ²) test is performed to determine whether the returns for stock i exhibit significant behavioral bias. Both the χ² statistic and the probability value (p-value) associated with this test are produced by the software. Those skilled in the art of statistics will understand that if the corresponding p-value is low enough, then the investor can conclude that bias is significant. For example if the p-value is 0.04 and the investor wants to use a 5% cut-off, then the bias is said to be statistically significant at 5%. However, if the maximum likelihood results generate a p-value of 0.08, then the investor can conclude that the bias is statistically insignificant at 5%. In the preferred embodiment, the chi-square test used is a one-sided likelihood ratio test.

A one-sided likelihood ratio test is performed on the null hypothesis that σ_{μ}=0 and, therefore, μᵢₜ=0 (Coelli, 1995). [For the half normal distribution, as the variance (σ_{μ}²) and thus the standard deviation (σ_{μ}) get closer and closer to zero, the standard deviation and the mean approach zero, so that a test of σ_{μ}=0 is equivalent to a test of μᵢₜ=0. Estimates of σ_{μ} are produced by the maximum likelihood procedure.] If the test based on the maximum likelihood estimates from the overvaluation model rejects the null hypothesis, there is evidence of statistically significant overvaluation (μᵢₜ>0) in block 206.

If the one-sided likelihood ratio test based on the maximum likelihood estimates from the undervaluation model rejects the null hypothesis, there is evidence of statistically significant undervaluation (μᵢₜ<0) in block 207.

If the likelihood ratio test detects no significant bias, then this ends the analysis of that particular model for the returns of company i (block 214). If the likelihood ratio test rejects the hypothesis that there is no bias, then the one-sided error term, μᵢₜ, and a fundamental valuation index are estimated.

An estimate of the degree of behavioral bias, [symbol] , can be calculated from the maximum likelihood estimates. The values of [symbol] for each time period for stock i are calculated for the overvaluation model in block 208. In block 209, the [symbol] values are calculated for the undervaluation model.

In this invention, these estimates are used to produce a fundamental valuation index (FVI) in block 210 for overvaluation and a FVI in block 211 for undervaluation. In the preferred embodiment of the invention, the index for company i is FVIᵢ=Σₜ₌₁^{T}wₜ [symbol] /T, where wₜ is the weight give to observation t (0≦wₜ≦1). Weights can be adjusted to allow the investor to give greater or less weight to behavioral errors in more recent periods. In one embodiment, wₜ=1, such that FVIᵢ=Σₜ₌₁^{T} [symbol] /T and FVIᵢ is the mean of [symbol] .

If FVIᵢ equals zero ( [symbol] =0), this indicates that market returns equal their fundamental economic values. A positive value of FVIᵢ indicates that returns are overvalued. A negative value of FVIᵢ indicates that returns are undervalued. A value of FVIᵢ further away from zero indicates a greater degree of behavioral bias regarding stock i during the sample period. FVIᵢ provides a score of the degree of overvaluation or undervaluation. A separate index is created for the overvaluation model and for the undervaluation model. Based on estimates from the overvaluation model, positive and larger values of FVIᵢ mean a greater degree of overvaluation. For the undervaluation model, negative and smaller values (i.e., further away from 0) of FVIᵢ mean a greater degree of undervaluation.

By calculating a moving average of FVIᵢ, over a period of time, the invention allows the investor to examine a smoothed trend in FVIᵢ. In one embodiment, an investor may choose to calculate the moving average over m previous trading days for each time t, the m-period moving average of FVIᵢ at time t. By making such a calculation over a substantial number of periods, the investor can observe how the moving average of FVIᵢ changes over time. For an overvalued stock, an increase in the moving average of FVIᵢ over time indicates rising overvaluation. For an undervalued stock, a decrease in the moving average of FVIᵢ over time indicates rising undervaluation.

Once the analysis is complete for company i, the estimation process is repeated for the next company under consideration. This estimation process continues until all N companies under consideration for inclusion in an investment portfolio have been evaluated for all time periods desired by the investor.

The development and use of the fundamental valuation index makes investment decisions easier for the investor. The above discussion illustrates the principles and scope of an embodiment of the invention. This invention allows the investor to (1) choose a shorter or longer time horizon (number of trading days), (2) decide which set of financial instruments to evaluate, (3) test for significant overvaluation and/or undervaluation, (4) calculate a FVIᵢ for overvalued and undervalued instruments, and (4) use a moving average of FVIᵢ to detect for changes and trends in behavioral biases.

The following examples are provided to illustrate the method and should not be used to limit the scope of the invention. The first example estimates whether or not the stock returns of the Toyota Motor Company are overvalued or undervalued. Two time periods are analyzed. The first represents a time when Toyota was more successful than other automobile companies, Jan. 16, 2009 through Jan. 21, 2010. This is a period when Toyota was growing rapidly in size and had recently become the largest car manufacturer in the world. Noise traders may have taken past success to signal future success, causing them to overvalue Toyota stock. The second period follows a major problem in early 2010 in which Toyota recalled over 4 million automobiles due to faulty accelerator pedals. This event may have caused noise traders to shy away from Toyota's stock, which would have eliminated any overvaluation bias. The second period begins after the recall episode, running from Apr. 22, 2010 through Apr. 21, 2011. Equation (5) is estimated for both periods using daily returns data. Rₘₜ is defined as the Standard and Poor 500 Index (S&P 500 Index), and μᵢₜ has a half-normal distribution. The results indicate that there was statistically significant overvaluation of Toyota's returns in the first period. When wₜ=1, FVI=0.140, which is greater than zero and indicates overvaluation. In the second period, there was no significant overvaluation or undervaluation.

The second example investigates the stock returns of 25 companies that were continuous members of the Dow Jones Industrial Average, 2005-2011. The Dow Index is based on the average stock value of the leading 30 publically traded corporations in the U.S. This period encompasses the great recession, which began in late 2007 and officially ended by mid 2009. To illustrate how this method can be used as an investment strategy, the following back testing procedure is used. Daily return data for each stock and for the S&P 500 are used with the composite error model in Equation (5) to identify stocks that are statistically significantly undervalued for each year from 2005 through 2010. At the beginning of 2006, $100 is invested equally among stocks that were significantly undervalued in 2005. At the beginning of 2007, these stocks are sold and all proceeds are invested equally among stocks that were significantly undervalued in 2006. This procedure is continued for each year through 2011.

The results show that this investment strategy earned a higher rate of return than the overall stock market. Investing in undervalued stocks using the 1 percent level of significance earns a rate of return of 49.5 percent. That is, investing $100 at the beginning of 2006 grows in value to $149.53 by the end of 2011. Investing in undervalued stocks using the 5 percent level of significance earns a rate of return of 24.93 percent. That is, the $100 investment increased in value to $124.93. During the same period, the Dow Index rose 12.64 percent, and the S&P 500 Index fell by 0.88 percent. This demonstrates how noise trading can lead to significant undervaluation and how the invention can be used to make profitable investments.

The above examples are further described with reference to the details provided as follows. The first case is for the Toyota Motor Company. Tables 1 and 2 list the standard statistical estimates of Toyota's composite error model (using the conventional Stata software package). Estimates in Table 1 are for Jan. 16, 2009 through Jan. 21, 2010. Estimates in Table 2 are for Apr. 22, 2010 through Apr. 21, 2011. In each table, column 2 provides the results from the overvaluation model, and column 3 provides results from the undervaluation model. The chi-square (χ²) statistic for the one-sided likelihood ratio test is used to test for overvaluation (column 2) and undervaluation (column 3). In the first period (Table 1), a chi-square value of 6.56 indicates that Toyota's returns were significantly overvalued at the 5 percent level of significance (p-value=0.005 is less than 0.050). The chi-square statistic of 0.0001 in the undervaluation model indicates that Toyota's returns were not significantly undervalued at the 5 percent level of significance (p-value=0.9999 is greater than 0.050). In the second period (Table 2), the chi-square statistic of 0.61 (p-value=0.218) in the overvaluation model and of 0.0001 (p-value=0.9999) in the undervaluation model indicate that Toyota's returns were neither overvalued nor undervalued at the 5 percent level of significance (both p-values exceed 0.050).

The second case investigates the stocks of the 25 companies that were continuous members of the Dow Index from 2005 through 2011. These companies are listed in Table 3. The table also identifies the rate of return from investing in each stock separately over a six year period, from the beginning of 2006 through the end of 2011. For example, investing $100 in 3M at the beginning of 2006 through 2011 would return $103.31 or a profit of 3.31 percent, while investing $100 in Alcoa would return $28.93 or a loss of 71.07 percent. As described above, the composite error model in Equation (5) is used to identify stocks that are significantly undervalued for each year, 2005-2010. At the beginning of 2006, $100 is invested equally among stocks that were significantly undervalued in 2005. At the beginning of 2007, these stocks are sold and all proceeds are invested equally among stocks that were significantly undervalued in 2006. This procedure is continued for each year through 2011.

Table 4 lists the return from investing in stocks that are identified by the composite error model as being undervalued. It also includes the returns from investing in the Dow Index or the S&P 500 Index. The results show that investing in undervalued stocks for an extended period earns a higher rate of return than investing in the Dow Index or the S&P 500. Investing in stocks that are undervalued at the 1 percent significance level earns a return of 49.53 percent and at the 5 percent significance level earns 24.93 percent. These compare favorably with those of the Dow Index, which earned 12.64 percent, and the S&P 500 Index, which lost 0.88 percent.

The results in Table 4 indicate that investing in undervalued stocks will not always be a profitable short-run strategy, as the Dow Index outperforms it in the individual years of 2006 and 2011. However, if we consider the four year period from 2007 through 2010, the returns from investing in undervalued stocks is even more impressive. These results are provided in Table 5, indicating that investing in undervalued stocks earned a return of 64.96 percent at 1 the percent level of significance and 14.25 percent at 5 percent level of significance. This was a period when the Dow Index lost 6.44 percent and the S&P 500 index lost 10.22 percent. Investing in undervalued stocks proved to be a good hedge against the financial risks associated with the great recession.

TABLE 1
Regression Estimates of the Toyota Market Model using the Composite
Error Models of Overvaluation and Undervaluation (Half Normal
Distribution, Jan. 16, 2009 through Jan. 21, 2010)

| Independent Variable | Overvaluation | Undervaluation |
|---|---|---|
| Intercept | −1.3388^{a} | 0.0773 |
| | (0.2074) | (1.0836) |
| Rₘₜ | 0.8436^{a} | 0.8514^{a} |
| | (0.0584) | (0.0598) |
| σ_{υ} | 1.1624^{a} | 1.5848^{a} |
| | (0.1229) | (0.0709) |
| σ_{μ} | 1.7659 | 0.0226 |
| | (0.2494) | (1.3523) |
| Likelihood-Ratio Test of σ_{μ} = 0 | | |
| χ² | 6.56^{a} | 0.0001 |
| P-Value | 0.005 | 0.9999 |

The sample size is 252 in each model, and standard errors are in parentheses.
^{a}Significant at 1 percent.

TABLE 2
Regression Estimates of the Toyota Market Model using the Composite
Error Models of Overvaluation and Undervaluation (Half Normal
Distribution, Apr. 22, 2010 through Apr. 21, 2011)

| Independent Variable | Overvaluation | Undervaluation |
|---|---|---|
| Intercept | −0.6646^{b} | −0.0008 |
| | (0.2742) | (0.9776) |
| Rₘₜ | 0.7291^{a} | 0.7311^{a} |
| | (0.0599) | (0.0599) |
| σ_{υ} | 0.9258^{a} | 1.0446^{a} |
| | (0.1098) | (0.0483) |
| σ_{μ} | 0.8010 | 0.0324 |
| | (0.3379) | (1.2225) |
| Likelihood-Ratio Test of σ_{μ} = 0 | | |
| χ² | 0.610 | 0.0001 |
| P-Value | 0.218 | 0.9999 |

The sample size is 254 in each model, and standard errors are in parentheses.
^{a}Significant at 1 percent.
^{b}Significant at 5 percent.

TABLE 3
Cumulative Returns of Investing $100 in Each of the 25 Dow Companies, 2006-2011

| Company | 2005 | 2006 | 2007 | 2008 | 2009 | 2010 | 2011 |
|---|---|---|---|---|---|---|---|
| 3M | 100 | 98.93 | 104.55 | 74.82 | 104.94 | 109.71 | 103.31 |
| Alcoa | 100 | 98.09 | 120.84 | 40.50 | 55.69 | 52.84 | 28.93 |
| American Express | 100 | 114.80 | 97.07 | 36.76 | 77.82 | 82.54 | 89.71 |
| ATT | 100 | 141.44 | 165.92 | 119.06 | 115.66 | 120.07 | 122.38 |
| Boeing | 100 | 126.59 | 122.97 | 64.24 | 79.76 | 94.26 | 104.13 |
| Caterpillar | 100 | 105.81 | 122.20 | 81.16 | 101.30 | 162.89 | 156.75 |
| Coca-Cola | 100 | 118.78 | 149.36 | 112.22 | 139.46 | 159.46 | 171.08 |
| DuPont | 100 | 113.89 | 101.58 | 60.80 | 79.56 | 116.19 | 106.32 |
| Exxon Mobile | 100 | 126.75 | 159.93 | 139.63 | 118.27 | 127.50 | 144.96 |
| General Electric | 100 | 107.35 | 103.93 | 48.26 | 43.68 | 51.68 | 50.64 |
| Hewlett Packard | 100 | 144.66 | 172.58 | 127.95 | 182.31 | 148.56 | 89.54 |
| Home Depot | 100 | 99.59 | 63.31 | 58.51 | 69.52 | 85.62 | 101.94 |
| Intel | 100 | 79.59 | 99.14 | 59.44 | 81.66 | 81.54 | 94.84 |
| IBM | 100 | 118.54 | 127.58 | 106.47 | 161.41 | 179.72 | 224.08 |
| Johnson and Johnson | 100 | 107.74 | 106.94 | 98.41 | 104.95 | 101.93 | 106.41 |
| JP Morgan Chase | 100 | 119.61 | 104.93 | 78.00 | 106.62 | 108.43 | 82.73 |
| McDonalds | 100 | 130.88 | 173.33 | 190.18 | 187.29 | 228.52 | 299.31 |
| Merck | 100 | 134.41 | 175.18 | 94.66 | 113.01 | 110.05 | 115.11 |
| Microsoft | 100 | 111.25 | 131.22 | 75.75 | 115.31 | 104.25 | 96.72 |
| Pfizer | 100 | 110.56 | 96.34 | 76.83 | 79.60 | 74.35 | 91.00 |
| Proctor and Gamble | 100 | 109.80 | 123.02 | 106.84 | 103.98 | 110.19 | 113.49 |
| United Technologies | 100 | 111.11 | 133.04 | 97.21 | 126.71 | 139.73 | 129.29 |
| Verizon | 100 | 124.49 | 142.23 | 114.02 | 109.55 | 119.91 | 132.06 |
| Walmart | 100 | 102.86 | 101.45 | 123.69 | 117.30 | 118.02 | 129.27 |
| Walt Disney | 100 | 140.16 | 130.49 | 98.03 | 131.43 | 155.00 | 153.69 |

TABLE 4
Returns from Investing $100 in Undervalued Companies (at the 1% and
5% significance levels), the Dow Index, and the S&P 500 Index,
2006-2011

| | 2005 | 2006 | 2007 | 2008 | 2009 | 2010 | 2011 |
|---|---|---|---|---|---|---|---|
| Under- | | | | | | | |
| valued | | | | | | | |
| Firms | | | | | | | |
| 1% | 100 | 103.35 | 117.33 | 90.94 | 116.75 | 170.49 | 149.53 |
| Signif- | | | | | | | |
| icance | | | | | | | |
| 5% | 100 | 109.70 | 126.90 | 98.36 | 113.86 | 125.33 | 124.93 |
| Signif- | | | | | | | |
| icance | | | | | | | |
| Dow | 100 | 115.00 | 120.25 | 83.29 | 97.57 | 107.59 | 112.64 |
| Index | | | | | | | |
| S&P 500 | 100 | 111.65 | 114.06 | 73.44 | 89.30 | 100.24 | 99.12 |
| Index | | | | | | | |

TABLE 5
Returns from Investing $100 in Undervalued Companies
(at the 1% and 5% significance levels), the Dow Index,
and the S&P 500 Index, 2007-2010

| | 2006 | 2007 | 2008 | 2009 | 2010 |
|---|---|---|---|---|---|
| Undervalued Firms | | | | | |
| 1% Significance | 100 | 113.53 | 87.99 | 112.97 | 164.96 |
| 5% Significance | 100 | 115.68 | 89.66 | 103.79 | 114.25 |
| Dow Index | 100 | 104.57 | 72.43 | 84.84 | 93.56 |
| S&P 500 Index | 100 | 102.16 | 65.78 | 79.98 | 89.78 |

The invention can be applied to a variety of circumstances and has numerous uses, including but not limited to the following. This method applies to periods of market upturns and downturns and to periods that precede or follow a major event, including but not limited to a war or merger. Applications of this method to various financial instruments and pluralities of instruments in the U.S. and in foreign markets will become apparent to those skilled in the art. An investor may anticipate earning greater expected returns by buying financial instruments that are undervalued and are expected to be less undervalued in the future and by selling financial instruments that are overvalued and are expected to be less overvalued in the future.

What is claimed is:

1. A computer implemented method of evaluating the valuation of financial instruments, comprising:
(a) receiving through a computer system capital market data on a predetermined financial instrument for each of a plurality of 1, 2, 3, . . . , N investment instruments over 1, 2, 3, . . . , T periods;
(b) receiving through said computer system financial data on each of predetermined market indices over said 1, 2, 3, . . . , T periods;
(c) calculating market returns for each said instrument and each said market index over said 1, 2, 3, . . . , T periods;
(d) estimating a regression model for instrument 1;
(e) determining a behavioral bias value for instrument 1;
(f) estimating a fundamental valuation index of overvaluation/undervaluation of returns for instrument 1 when said behavioral bias value for instrument 1 is statistically significant;
(g) calculating a moving average of said fundamental valuation index of overvaluation/undervaluation for instrument 1;
(h) repeating steps (d) through (g) for said 2, 3, 4, . . . , N instruments to be evaluated to provide a plurality of evaluated instruments; and,
(i) determining which of the plurality of evaluated instruments are overvalued/undervalued.

2. The system in claim 1, wherein the computer implemented method further determines the fundamental valuation index with variable weights, giving greater or less weight to behavioral errors in more recent periods, later periods, or periods surrounding economic events, to further identify the plurality of evaluated instruments that are overvalued/undervalued.
